(19) United States
(12) Patent Application Publication
(10) Pub. No.: US 2018/0293312 A1
(43) Pub. Date: Oct. 11, 2018

(54) Computerized Method and System for Organizing Video Files

(71) Applicant: Tony Tateossian, Glendale, CA (US)

(72) Inventor: Tony Tateossian, Glendale, CA (US)

(21) Appl. No.: 16/009,971

(22) Filed: Jun. 15, 2018

Related U.S. Application Data
(63) Continuation-in-part of application No. 14/638,991, filed on Mar. 4, 2015.

(51) Int. Cl. G06F 17/30; G06F 17/27

(52) U.S. Cl. CPC G06F 17/30828; G06F 17/30793; G06F 17/3084; G06F 17/30796; G06F 17/277; G06F 17/30787

(57) ABSTRACT

A computer implemented method and system for organizing video files is disclosed. The software creates a database of source files. The source files are utilized as sources of information pertinent to a video file. The software stores video files in a database. Information from the source files is used to create a ranking and grouping of associated video files. The software also measures the facial features of a person in a video file. The facial features measured are compared against data of facial features in source files. The facial features are also measured for the amount of time appearing on a person's face. A rating of a video file depends on a set of weighted inputs. The system is a self-learning system to increase the reliability of ranking of video files. Several servers may operate as a blockchain to assign reliability and accuracy rankings to video files.

### PRIORITY

This application is a continuation-in-part of U.S. application Ser. No. 14/638,991, filed on Mar. 4, 2015, the disclosure of which is fully incorporated herein.

### FIELD OF THE INVENTION

The invention pertains generally to computer communications and more particularly to a computerized method and system to track and rate video files.

BACKGROUND OF INVENTION

The Internet is used as a modern day soapbox of sorts, with opinions on all topics being offered and more. Indeed, the Internet provides a platform for the everyday consumer to share a comment or rate a product purchased, a service provided, a venue visited, an event attended, and the like. Acts of this nature have become an important source of information in the marketplace. For example, a positive act may lead to the purchase a product or service, whereas a negative act may quash the deal. Many of these services are utilized by means of online video files. Internet users search the internet for video files and consume content through watching these videos. However, the large amount of video content can make it difficult to know what content to consume or trust. Therefore, there is a desire to organize video files based on the “trustworthiness” of the content of a video. The “trustworthiness” of a video can be determined by seeking out source data from additional files, storing those source files in a database, and comparing video content or video information to the information from the source files.

Lastly, there is a desire to measure “trustworthiness” or “truthfulness” by detecting facial movements of a person in a video file. Facial movements and positions can be utilized to determine if the person in the video is telling the truth.

Accordingly, systems and methods that obtain information pertinent to a video file and then evaluate that information to determine the credibility of the content, written or otherwise, are desired. What is needed is a computerized system and method for automatically identifying and rating a video file.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention is directed toward a computer implemented method for organizing and rating video files comprising obtaining a first computer storage location for a first video file; recording said first computer storage location to a database; searching for one or more source files; obtaining one or more source files; extracting data from said one or more source files; extracting data from said first video file; comparing data from said one or more source files to data from said first video file; generating a first trust rating value for said first video file; and storing said first trust rating value in said database.

The computerized method may further comprise receiving a query from a communicatively connected computer; searching said database for a video file record; identifying a video file record responsive to said query; and transmitting an answer to said query. The computerized method may further comprise obtaining a source file storage location for a source file; and recording said source file storage location in a database.

In another embodiment of the invention one of said one or more source files further comprises facial data information. In this embodiment the method may further comprise obtaining facial information from said first video file; comparing facial information from said first video file to facial data information from said source file; generating a facial information output value; and incorporating said facial information output value into said first trust rating value.

In another embodiment of the invention one of said one or more source files further comprises vocal data information. In this embodiment the method may further comprise obtaining vocal information from said first video file; comparing said vocal information from said first video file to vocal data information from said source file; generating a vocal information output value; and incorporating said vocal information output value into said first trust rating value.

In another embodiment of the invention one of said one or more source files further comprises source user profile information. In this embodiment the method may further comprise obtaining user profile information of an author of said first video file; comparing source user profile information to a user profile information of an author of said first video file; generating a user profile output value; and incorporating said user profile output value into said first trust rating value.

In another embodiment of the invention one of said one or more source files further comprises a first IP address of a computer. In this embodiment the method may further comprise obtaining a second IP address of a computer; comparing said first IP address to said second IP address; generating an IP address output value; and incorporating said IP address output value into said first trust rating value.

In another embodiment of the invention the computerized method may further comprise obtaining one or more accuracy feedback values; storing said one or more accuracy feedback values in a database; comparing said one or more accuracy feedback values to said first trust rating value; generating a second trust rating value for said first video file; searching, in a database, for a second video file record pertaining to a second video file; generating a third trust rating value for said second video file; storing said third trust rating value in a database; and altering said second video file record to reflect said third trust rating value.

In another embodiment of the invention the computerized method may further comprise respectively receiving one or more second trust rating values for said first video file from one or more second computers; comparing said first trust rating value to said one or more second trust rating values; generating a third trust rating value for said first video file; and transmitting said third trust rating value to one or more second computers.

In another embodiment of the invention the computerized method may further comprise determining one or more spoken words in an audio track of said first video file; generating a transcript of said one or more spoken words in said audio track of said first video file; and storing said transcript in a database.

In this embodiment of the invention one of said one or more source files further comprises a wordlist, and said method further comprises comparing said transcript to said word list; generating a word list output value; and incorporating said word list output value into said first trust rating value.

In this embodiment of the invention one of said one or more source files further comprises transaction information and said method further comprises comparing transaction information to said transcript; generating a transaction output value; and incorporating said transcript output value into said first trust rating value.

In this embodiment of the invention the computerized method may further comprise generating a list of words appearing in said transcript; respectively determining a number of times each word in said list of words appears in said transcript; generating a lexicon output value; and incorporating said lexicon output value into said first trust rating value.

In this embodiment of the invention the computerized method may further comprise obtaining metadata related to said first video file; comparing said metadata related to said transcript; generating a metadata output value; and incorporating said metadata output value into said first trust rating value.

The computerized method may further comprise generating two or more source file output values; respectively applying a weight value to said two or more source file output values; and incorporating said two or more source file output values into said first trust rating value after applying said weight value. In this embodiment of the invention the computerized method may further comprise generating a visual representation of two or more source file output values, wherein said visual representation is configured as a multi-dimensional space image.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a schematic of the environment in which the disclosed invention operates;

FIG. 2 is a flow chart illustrating a high-level overview of one or more aspects of the disclosed embodiments;

FIG. 3 is a representative illustration pertinent to acquiring an identifier for an item;

FIG. 4 is a representative illustration pertinent to obtaining information relevant to the identifier from a plurality of sources;

FIG. 5 is a representative illustration pertinent to evaluating relevant information;

FIG. 5A is a representative illustration pertinent to generating an output;

FIG. 6 is a flow chart illustrating one or more aspects of the disclosed embodiments pertinent to lexicon;

FIG. 7 is a flow chart illustrating one or more aspects of the disclosed embodiments pertinent to IP/ship proximity;

FIG. 8 is a schematic of the computer system performing the inventive method;

FIG. 9 is a schematic of a public database;

FIG. 10 is a schematic of a storage database;

FIG. 11 is a schematic of a database file;

FIG. 12 is a schematic of a database file;

FIG. 13 is a schematic of the inventive method;

FIG. 14 is a schematic of the inventive method;

FIG. 15 is a schematic of the inventive method;

FIG. 16 is a schematic of the inventive method;

FIG. 17 is a schematic of the inventive method; and

FIG. 18 is a schematic of the inventive method.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component.

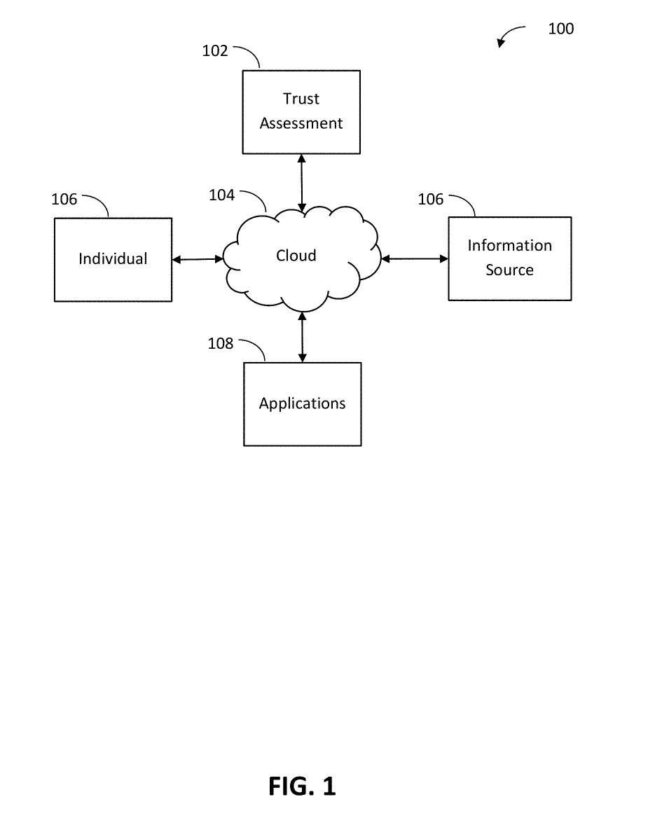

FIG. 1 illustrates an example environment in which a system or method embodying one or more aspects of the disclosed invention may operate. As seen in FIG. 1, cloud 104 represents various systems and hosts in which one or more interconnected networks may communicate with each other. Individual 106 represents a person, autonomous application, or client service acting on behalf of a person. Individual 106 may communicate using any method available in the cloud 104 including but not limited to web browsers, mobile applications, hosted applications, kiosks, or specialized devices. In a particular embodiment, cloud 104 may be common to all participating elements. In other embodiments, cloud 104 may be different for each type of communication. Cloud 104 may provide communication over private networks, wireless networks, satellite networks, cellular networks, paging networks, wide area networks, or other network-addressable systems.

In the environment illustrated by FIG. 1, individual 106 communicates through cloud 104 with one or more applications 108. The application 108 may communicate through the same cloud 104 or through a different cloud with a trust assessment service 102 embodying one or more aspects of the disclosed invention. The trust assessment service 102 will assess the available information and provide an evaluation of trust. To determine the level of trust, the trust assessment service 102 may retrieve additional information from one or more information sources 106. Access to the additional information may be through a common cloud 104 or through alternate clouds. The amount and type of information available may vary from assessment to assessment so the trust assessment service 102 adapts to the amount of information available and provides a qualified determination of trust, as disclosed in more detail below.

Exemplary embodiments as described herein may be implemented utilizing a computing device and a network having access to a plurality of nodes one or more of which can host a server with data. A computing device may include a user interface to facilitate interaction with a user. A computing device may be a personal computer, a portable computer, a smartphone, or the like. Servers or data storage devices at a network location may include files that are of interest to the user, as well as other relevant information. The storage devices may be located in the server and accessible to the user device over a network in a conventional manner.

As such, one aspect of the disclosed subject matter includes a system for evaluating the credibility of a video file comprising a user interface, a communication interface for communicating with a plurality of information sources, and a processor for submitting a query to one or more of the information sources via the communication interface. The disclosure herein may refer to “review” which should be deemed to mean the same thing as a video file itself, including the content of the video file. The query may include a request to receive information about an item that is the subject of the video file. The same or related processor may be then be configured to assess the video file and all pertinent information related thereto, and then generate a trustworthiness score based on the assessment. As understood by those skilled in the art, part or all of the disclosed subject matter may be executed in any combination of mobile platforms and computing devices.

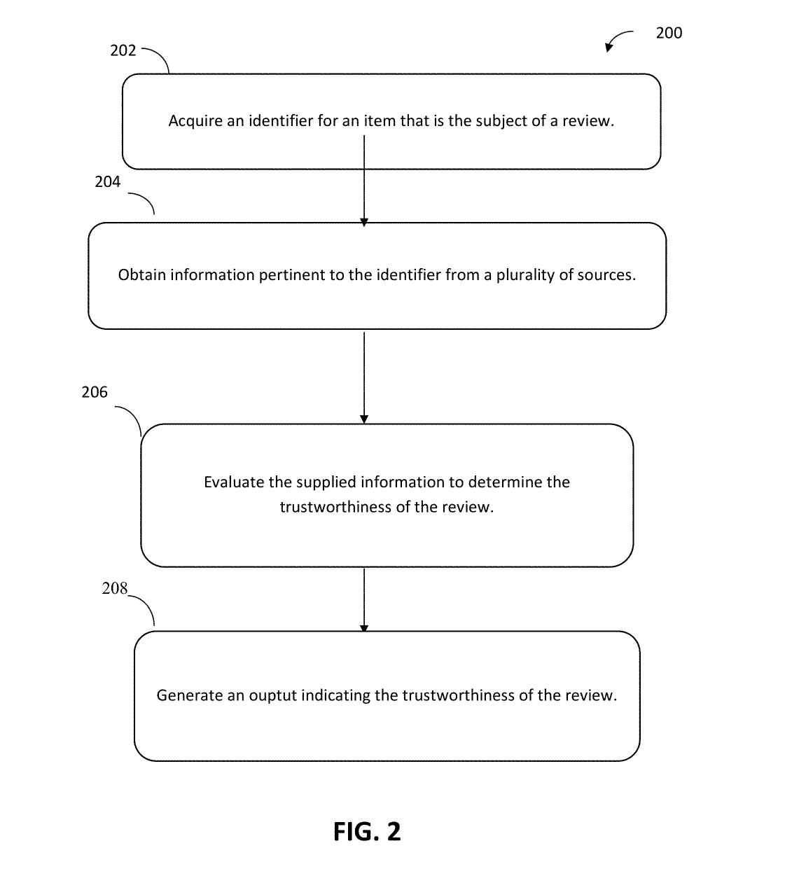

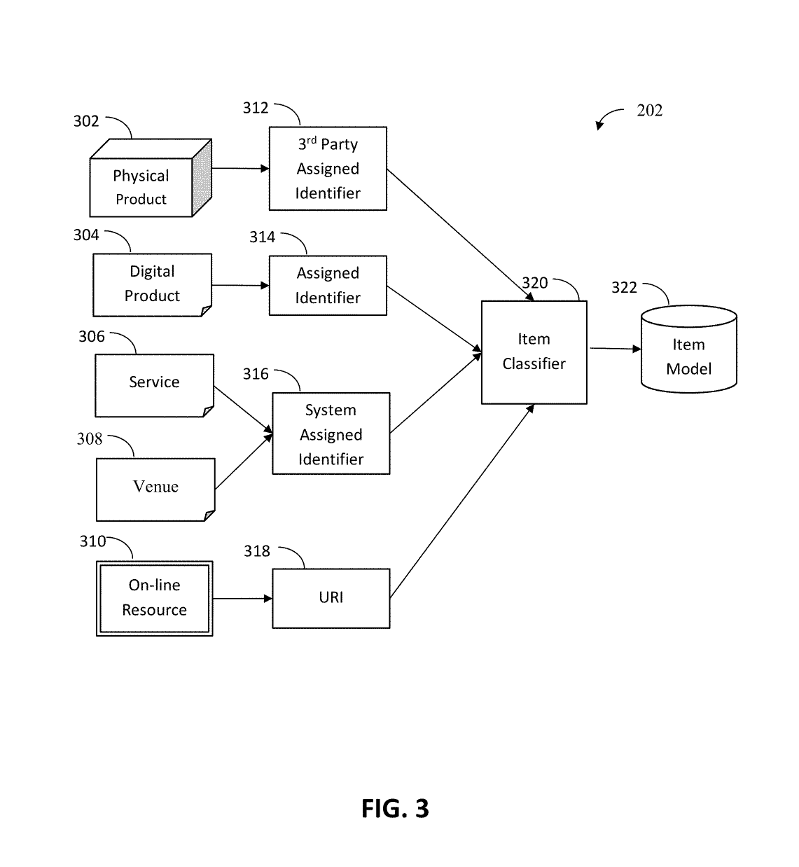

FIG. 2 is a flow chart illustrating a high-level overview of one or more aspects of the disclosed embodiments. As seen in FIG. 2, block 202 entails acquiring an identifier for an item that is the subject of a video file. The identifier is preferably a unique identifier that may be acquired by an individual by scanning a bar code, a quick response code, an image, or like encoding. Scanning may be done via a smartphone or the like by taking a picture or video of the product and/or code itself, the latter of which may be printed for display in a store or on a business card, for example. The picture or video may then be uploaded. In a similar manner, a consumer may use one or more aspects of the disclosed embodiments to upload a picture or video file. The identifier may also be acquired through a search, a location service, other like techniques, as disclosed in more detail below regarding FIG. 3.

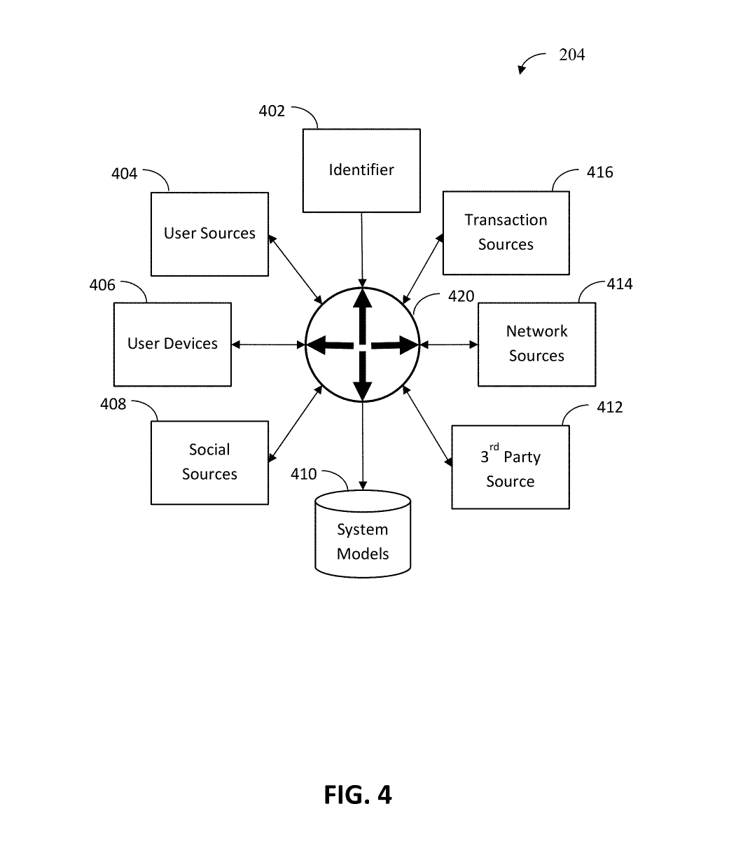

Once the identifier has been acquired, the next step preferably involves obtaining information pertinent to the identifier from one or more sources, as seen in block 204 of FIG. 2 and disclosed in more detail below in the context of FIG. 4. The collection of information is then evaluated in block 206 to determine the trustworthiness of video file information provided. In some embodiments, this collected information is stored in memory and persists at least until the assessment completes. In other embodiments, the information is placed in a storage media that may be local or in the cloud. Once evaluated, an output is generated indicating the trustworthiness of the video file, as illustrated in block 208.

FIG. 3 is a representative illustration pertinent to acquiring an identifier for an item that is the subject of a video file, as exemplified in block 202 of FIG. 2. In the context of the disclosed subject matter, each video file is about an item. As used herein, an item refers to a physical product 302, a digital product 304, a service 306, a venue 308, or an on-line resource 310. However, an item as understood herein need not be so limited but may include other related concepts. As seen in FIG. 3, a physical product 301 may have an identifier assigned by a third party 312. A digital product 304 may be assigned an identifier, as per block 314. A service 306 or venue 308 may have an identifier assigned by a sub-system 316. An on-line resource 310 may be identified by its uniform resource identifier or URI, as per block 318. Each of these identifiers 312-318 may be classified and/or categorized by an item classifier 320 for further use as an item model 322 or the like by one or more other aspects of the disclosed invention.

FIG. 4 is a representative illustration pertinent to obtaining information relevant to the identifier from a plurality of sources, as exemplified in block 204 of FIG. 2. As seen in FIG. 4, upon receiving an identifier 402, the multi-information collection sub-system 420 disclosed herein may obtain information about user sources 404, the device being used 406, social sources 408, system models 410, third party sources 412, network sources 414, transaction sources 416, and the like.

User device 406 information may include the geographic location of the device being used to generate the video file, user identification, and type of device. In the context of social services 408, a social source may include information pertinent to a given name, location, preferences, or associations. Example social sources include Facebook, Twitter, and LinkedIn. A third party source 412 may provide independent confirmation of information from other sources. For example, identity information of an actor may be confirmed through a bureau or a business member list. Network sources 414 may include information about the IP address of the actor's device. Transaction sources 416 may include information about the item comprising the purchase of goods or services, attendance at an event, and the like. The collection sub-system 420 may also obtain corollary information from the actor upon request to the actor.

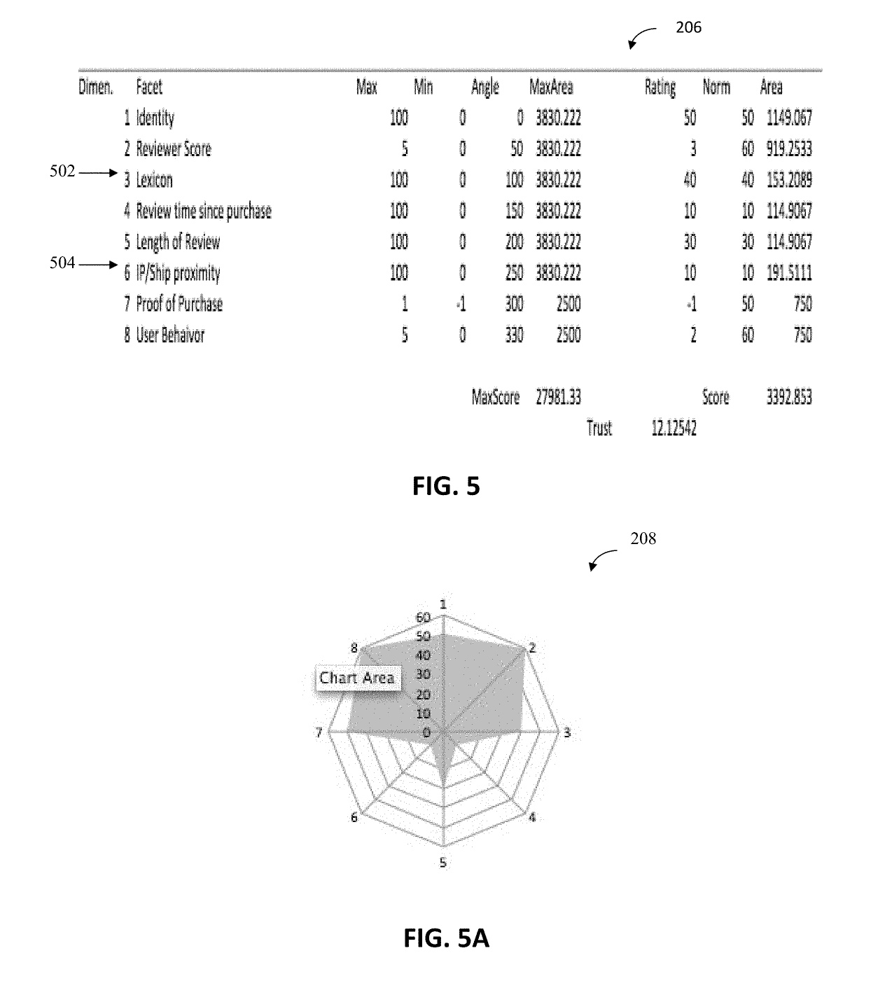

FIG. 5 is a representative illustration pertinent to evaluating information relevant to a video file to determine the trustworthiness of the video file, as exemplified in block 206 of FIG. 2. As seen in FIG. 5, determining the trustworthiness of a video file may include an evaluation of several facets or factors. The factors may include but are not limited to the identity of the actor, i.e., whether the individual writing the video file is who he or she claims to be, the actor's score, the lexicon employed by the actor (see call-out 502), review time since purchase, length of review, IP/ship proximity (see call-out 502), proof of purchase, and user behavior. Each factor may be treated equally in the evaluation or, in the alternative, treated differently by given more weight to one compared to another. For example, the identity of the user may be given a higher weight compared to proof of purchase, as illustrated in FIG. 5.

Each factor of a video file, whether text or other form, may be combined with other factors, including those from other sources and using other methods, to form a multi-dimensional space. This multi-dimensional space may be compared to shape models for trust and truthfulness. How well the multi-dimensional space matches the shape model may be expressed as a number on a fixed scale, providing a concise measure of trust and truthfulness. This number may be displayed in many forms including a number, star rating, a gradient bar, or other useful visual form. One such visual representation or output indicating the trustworthiness of the video file, per block 208, is illustrated in FIG. 5A.

In the context of using a score or the like as a visual representation, a higher score preferably indicates a higher trust in the video file. A lower score indicates a lower trust in the video file. An actor who has received a sufficient number of sufficiently high scores may even be given a badge or other indicia to provide an impression of overall trustworthiness.

To elaborate further with regard to how factors may be used and weighted in a trustworthiness evaluation process, a higher score may be generated as an output when an actor identified by their IP address, for example, discusses similar products and/or services. Conversely, if the same actor discusses unrelated items, then the score may be lower. Similarly, if an actor's social profile is obtained via one or more social sources 408, such information may be used to designate an actor as being knowledgeable about a particular product or service. By way of further example, if an actor responds to comments to the video file, then the score may be higher due to such user behavior. The rate at which video files are submitted may also be used to determine the score. If the video files are submitted in quick succession, the score may be lower. If the video files are submitted in a gradual manner, the score may be higher.

Businesses selling products or services may also provide credentials (in the form of a pin number or a bar code, for example) to purchasers of their products or services. The purchasers may then use these credentials to validate the video files of the purchased products or services. The actor may input their credentials before providing a video file. The score for actors with valid credentials may be higher than those without such credentials.

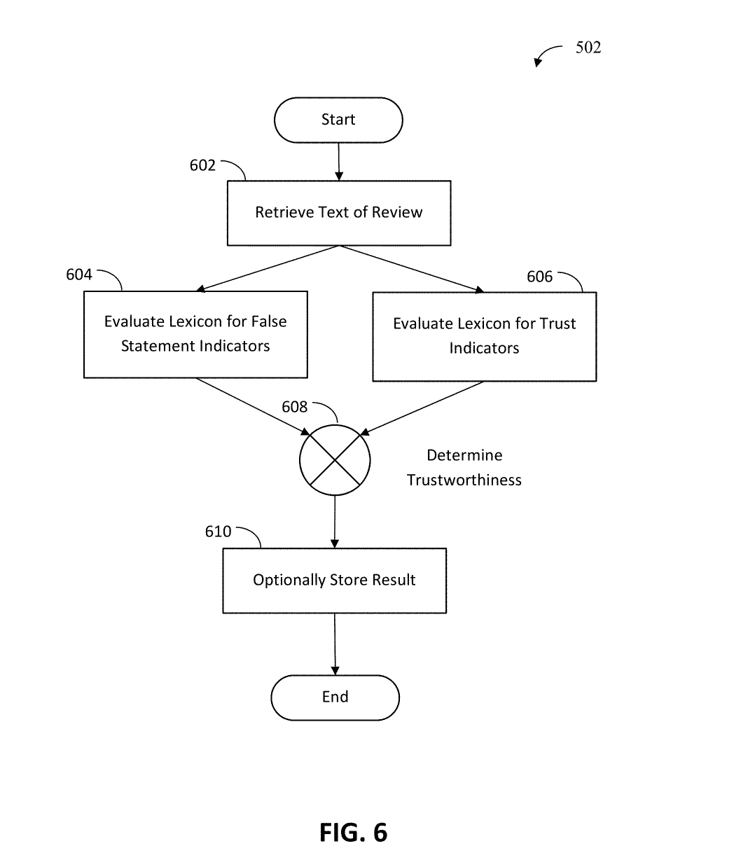

FIG. 6 is a flow chart illustrating one or more aspects of the disclosed embodiments pertinent to lexicon 502, as exemplified in FIG. 5, to determine the truthfulness of statements made in a video file. Such analysis is used to determine if word usage, phrasing, and/or expressions are typical or indicative of truthful statements. The likeliness of truthfulness may also be rated on a scale, such as that illustrated in FIGS. 5 and 5A. A method for performing lexicographic analysis is described in, for example, U.S. Patent Publication No. 20070010993, the subject matter of which is incorporated herein by reference.

Turning in detail to FIG. 6, a method in accordance with an exemplary lexicographic analysis may commence at step 602 wherein the text of a video file is retrieved. Where content of the video file is already in written form, the text of the video file is extracted and inputted into the trust assessment block 102 to be evaluated. Where the content of the video file contains spoken words, a transcript of verbal statements is preferably generated and then inputted into the trust assessment block 102. Once inputted, the text is evaluated for false statement indicators, per block 604, and also evaluated for trust indicators, per block 606. These evaluations are preferably combined at block 608 to determine a trustworthiness score, which may optionally be stored as per block 610. Moreover, for spoken words in a video file, characteristics of the speech patterns may also be assessed including the cadence of the speech, vocal expression, and occurrence of speech disfluency. Also, for the video file, further analysis may include determination of eye movement, facial expressions (including micro-expressions), body language, emotions, and scene composition that may be used to determine the truthfulness of the speaker. A method for evaluating facial expressions is described in, for example, U.S. Patent Publication No. 20130300900, the subject matter of which is incorporated herein by reference.

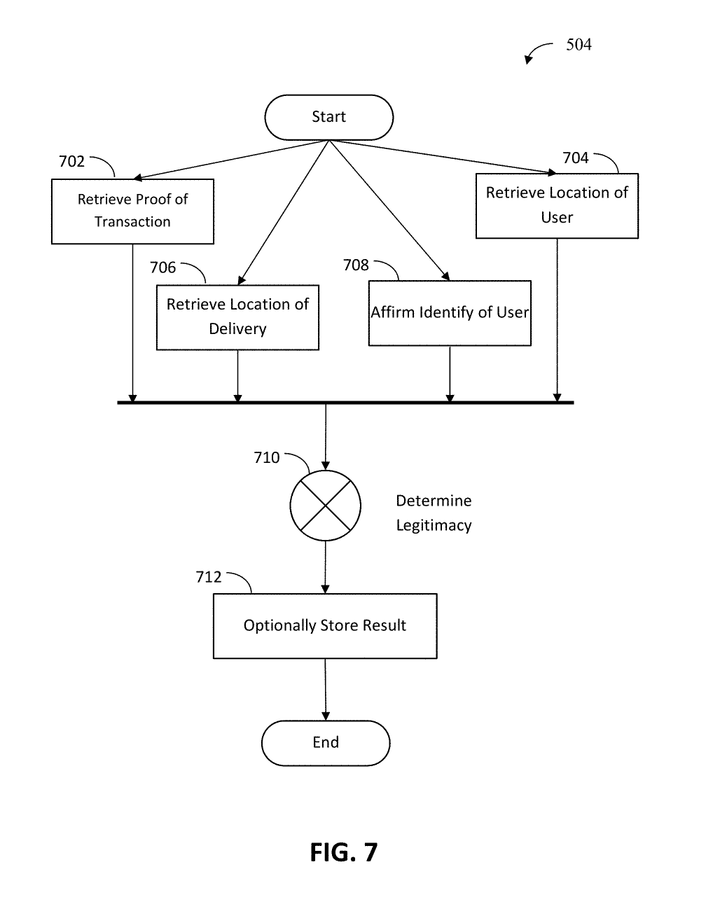

FIG. 7 is a flow chart illustrating one or more aspects of the disclosed embodiments pertinent to IP/ship proximity 504, as exemplified in FIG. 5. As seen in FIG. 7, a supplemental criterion for validating an actor may include matching proof of purchase and delivery of a product or service to an actor. Accordingly, a first step preferably involves retrieving proof of transaction, per block 702, while also retrieving the location of the user, per block 704. In addition, the location of delivery may be retrieved, per block 706. Moreover, the identity of the actor is preferably affirmed, per block 708. Next, the legitimacy of the actor is determined, per block 710. This determination is optionally stored, per block 712.

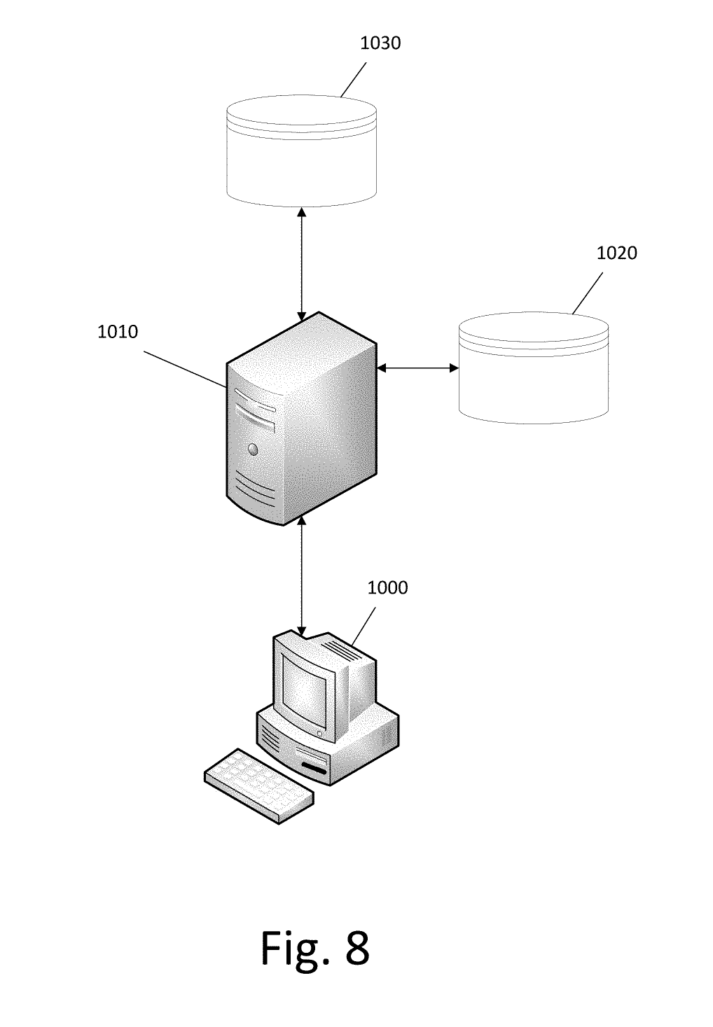

FIG. 8 illustrates a schematic of the computer system operating the method of the invention. The system comprises a client computer 1000 communicatively connected to a server 1010. The server 1010 is communicatively connected to a storage database 1030 and a public database 1020. The storage database 1030 may be any type of database and may be integral to the server 1010 or separate from the server 1010. In other embodiments the storage database 1030 and the public database 1020 may be the same database. The storage database 1030 is a database which stores information pertinent to the operation of the inventive method for fast storage and access. The public database 1020 is any database which stores publicly accessible information. Information may be obtained from the public database 1020 by means of scrolling, crawling, bots, spiders, or any other automated computerized method. The information obtained may then be transferred by the server 1010 from the public database 1020 to the storage database 1030. Alternately, the server 1010 may place a pointer on the storage database 1030 which points any query to the location of storage on the public database 1020.

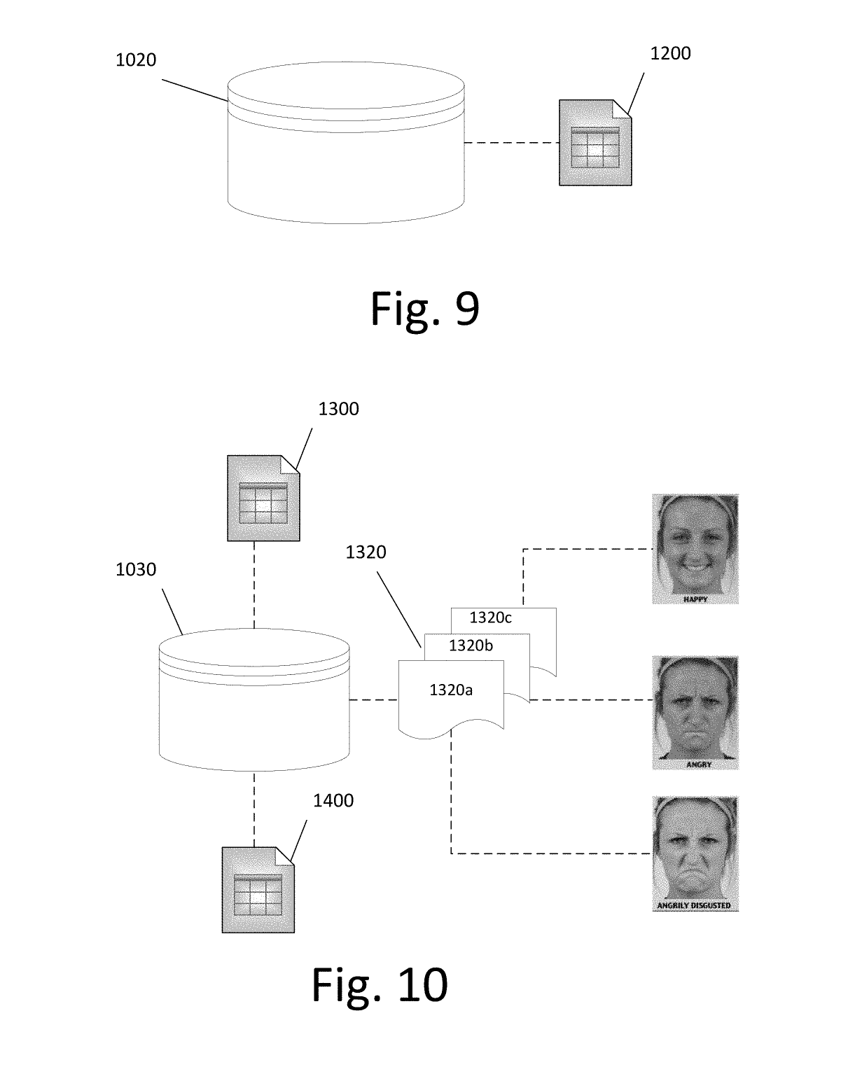

Referring to FIG. 9, a schematic of the public database 1020 is illustrated. The public database 1020 is any type of database and stores any type of information which is pertinent to the inventive method. As illustrated in the figure, the public database 1020 stores a video file 1200. The video file 1200 is any type of computer file used for showing a video. The video file 1200 may be in any format, such as .wmv, .avi, .gif, .mov, .amv, .mp4, flash, or any other video file format. The content of the video file 1200 preferably has published information concerning an opinion of an author. The opinion may concern any type of product or service. The video file 1200 may or may not contain audio information. In alternative embodiments the video file 1200 may have an accompanying text file describing the contents of the video or which is a transcript of the audio of the video file 1200. The audio information may contain spoken word concerning the opinion of the author. Although the invention is described in terms of a video file 1200, the computer method of the invention may be used with any type of file, such as written text, html sites, audio files, or any other type of publicly available file. A video file 1200 may be stored on a public database 1020, a storage database 1030, a private database, or all of the above.

Referring to FIG. 10, a schematic of the storage database 1030 is illustrated. The storage database 1030 is any type of database and stores any type of information or files. The storage database 1030 stores a storage database file 1300. The storage database file 1300 is a database concerning the location and access to files stored on the storage database 1030 or any public database 1020. The storage database 1030 also stores one or more records 1320, or source files. Each record 1300 may be any file type and may contain any type of information. A record 1320, or source file, may contain text, images, videos, audio, or any recorded information in any format. A record 1320, or source file, is any file stored in a computer database from which information may be extracted and compared to a video file 1200. A record 1320, or source file, may be stored on a public database 1020, a storage database 1030, a private database, or all of the above.

In the illustrated embodiment, the storage database 1320 contains a plurality of image files 1320a, 1320b, 1320c. The image files 1320a, 1320b, 1320c illustrated are facial images. The image files 1320a, 1320b, 1320c showing the facial images are used for comparison against an author's face recorded in a video file 1200. The storage database 1030 also has a trust database file 1400. The trust database file 1400 contains information concerning a plurality of video files 1200.

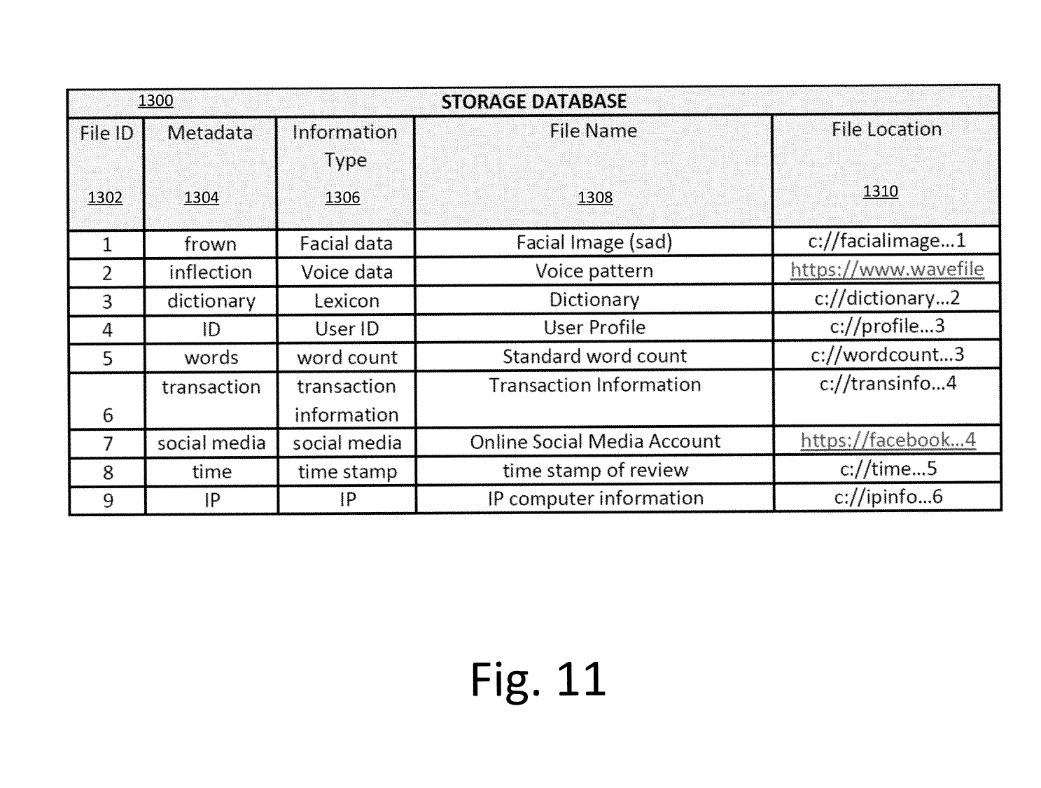

Referring to FIG. 11, a schematic of the storage database file 1300 is illustrated. The storage database file 1300 contains all information pertinent to background information and files utilized to perform a trust rating about a video file 1200. The storage database file 1300 can be utilized to organize information, data, and files and can be searched. The storage database file 1300 may contain any amount of information and may contain any number of fields and individual records. In the preferred embodiment, fields utilized in the storage database file 1300 include a File ID field 1302, a Metadata field 1304, an Information Type field 1306, a File Name field 1308, and a File Location field 1310. The File ID 1302 is a number which individually identifies a record stored in the storage database file 1300. The Metadata 1304 contains any tag of information to identify the type of information stored at a field. The Metadata 1304 may be utilized to sort and organize the separate records in the storage database file 1300. The Information Type 1306 contains information regarding the type of file or type of information stored in a record. The File Name 1308 is a name attributed to the file or record utilized for processing. The File Location 1310 is a pointer to the storage location of the file or information utilized in processing the information. The File Location 1310 may point to a location on the storage database 1030, a public database 1020, or a server 1010. The File Location 1310 may point to a computer file storage location, a domain name, or an IP reference number.

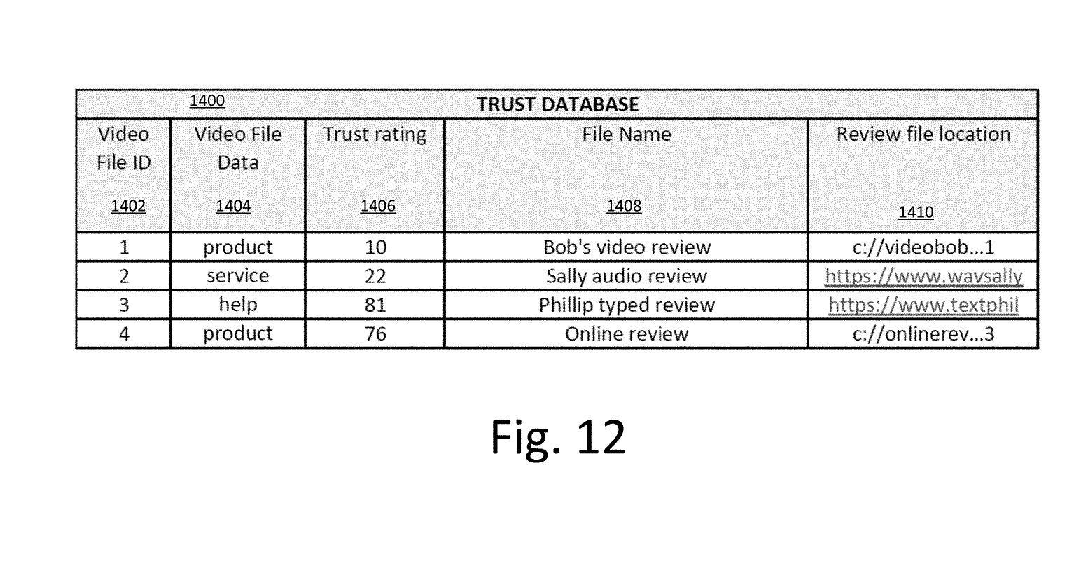

Referring to FIG. 12, a schematic of the trust database file 1400 is illustrated. The trust database file 1400 is utilized to store and arrange information related to a video file 1200. The trust database file 1400 may contain any type of information, any number of fields, and any number of records. In the preferred embodiment the trust database file 1400 contains a Video File ID field 1402, a Video File Data field 1404, a Trust Rating Field 1406, a File Name 1408, and a Video File Location field 1410. The Video File ID 1402 is a number which uniquely identifies a record stored in the trust database file 1400. The Video File Data 1404 contains any tag of information to identify the type of information contained in a video file 1200. The Video File Data 1404 may contain information about a product or service. The Video File Data 1404 may be utilized to sort and organize the separate records in the trust database file 1400.

The Trust Rating 1406 is a combined algorithmic score rating the honesty and trustworthiness of the video file 1200. The Trust Rating 1406 represents the amount of belief and faith which a user may place in the contents of a video file 1200. The Trust Rating 1200 removes a subjective value a user would place on a video file 1200 and replaces it with a weighted objective value based on pertinent information obtained from numerous public databases 1020 when compared against known information stored on the storage database 1030. The Trust Rating 1406 may be based on any scale. The Trust Rating 1406 may be a higher number based on the greater amount of truth and honesty based in the video file 1200.

The File Name 1408 is a name attributed to the video file 1200. The Video file Location 1410 is a pointer to the storage location of the video file 1200. The Video file Location 1410 may point to a location on the public database 1020. The Video file Location 1410 may point to a computer file storage location, a domain name, or an IP reference number. The Video file Location 1410 may point to a locally stored video file 1200 or be an embedded link to a video file 1200 stored in a connected storage location such as an internet website address.

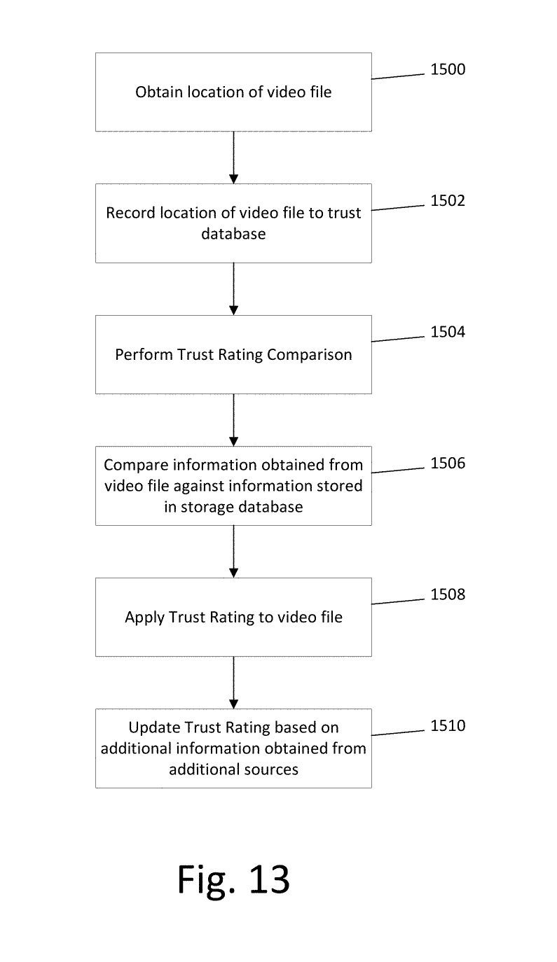

Referring to FIG. 13, the method of establishing the trust database file 1400 is illustrated. The method is performed by one or more computers. First the computer obtains the location of a video file 1500. The computer then records the location of the video file to the trust database file 1502. The computer then performs the trust rating comparison 1504. The comparison is primarily the computer comparing information obtained from the video file against information stored in the storage database file 1506. The computer applies the trust rating to the video file 1508. The computer may update the trust rating based on additional information obtained from additional sources or additional information stored in the storage database file after the initial application of the trust rating 1510.

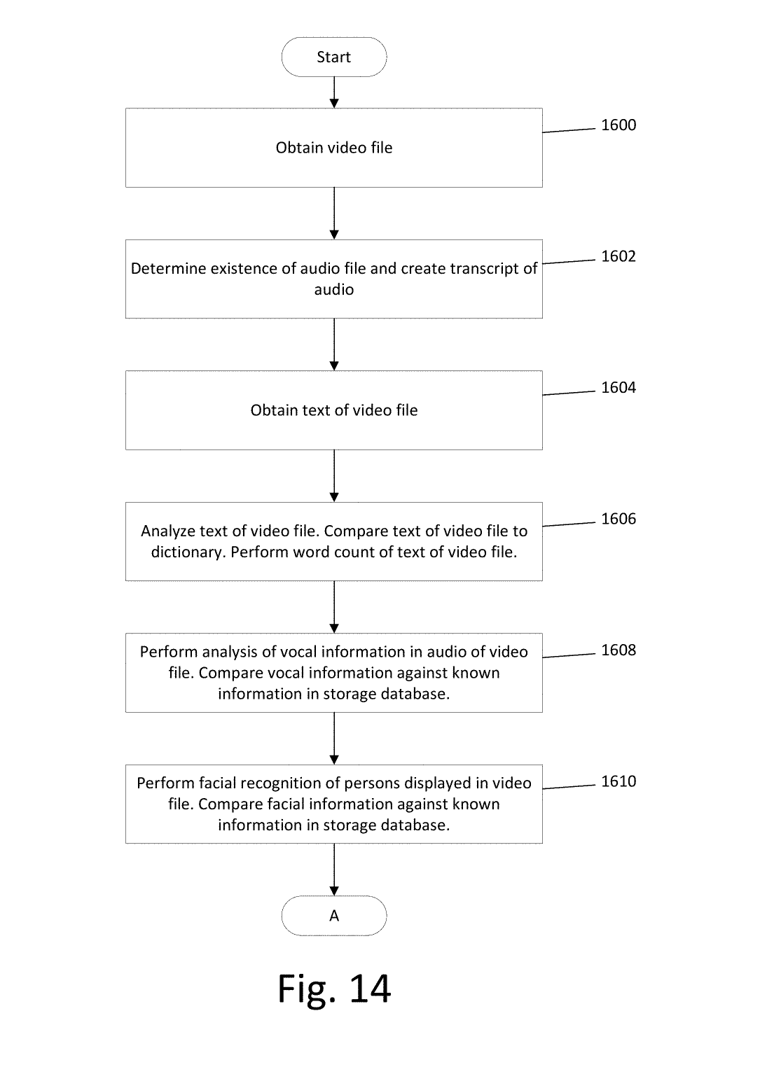

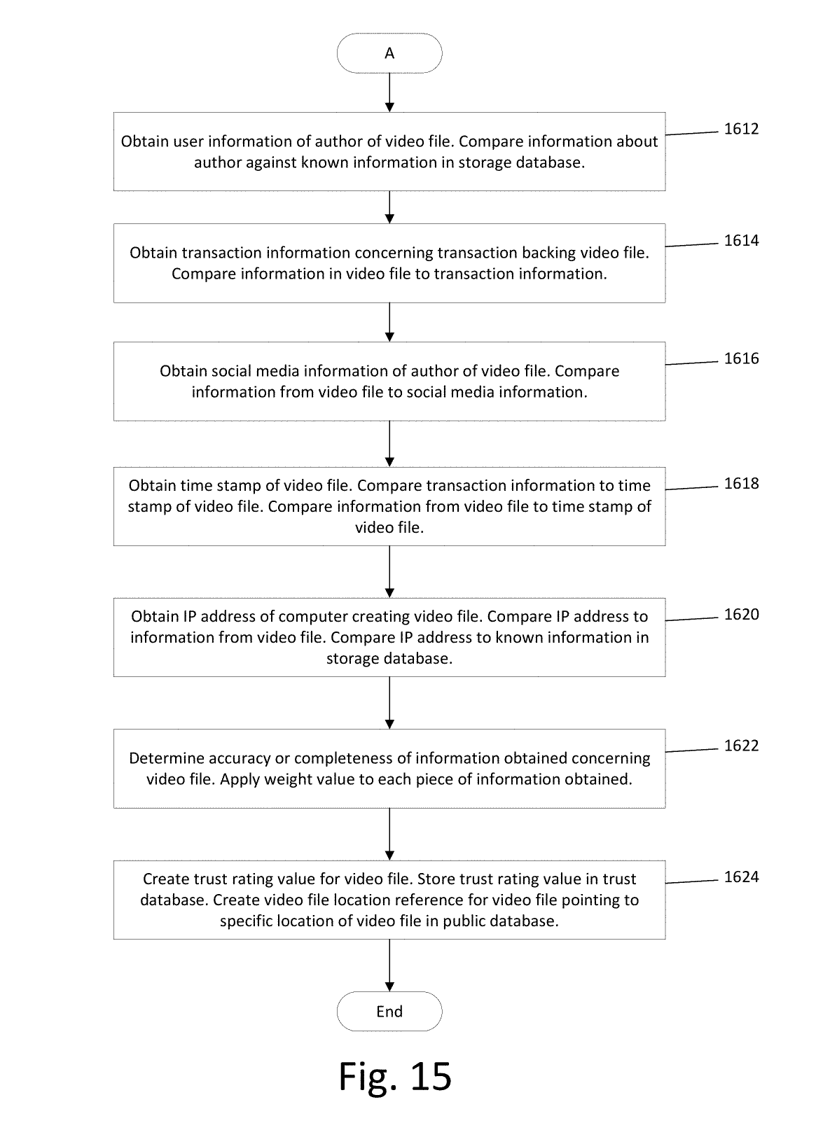

Referring to FIG. 14 and FIG. 15, the method of establishing the trust rating is illustrated. The computer may perform all or some of these steps in applying the trust rating to the video file. First the computer obtains the video file 1600. The computer determines the existence of audio in the video file and creates a text transcript of the audio 1602. The computer then obtains the text of the video file 1604. The text could be the text of the audio, text in the body of the video file, or both. The computer analyzes the text of the video file by comparing the text of the video file against a dictionary and performs a word count of the text of the video file 1606. The computer may determine the existence of flaws in the text such as improper grammar usage and misspellings. The computer may also perform a linguistics analysis of the text, such as determining the number of times each word is used and likelihood that one word is likely to appear next to another word.

If the video file has audio, the computer then analyzes the vocal information in the audio file and compares the vocal information against known information in the storage database 1608. This method may include determining fluctuation in pitch, tempo, intonation, or decibel level of speech. The known information used for comparison may be an audio file of the same speaker, an audio file of a different speaker, or an amalgamation of information obtained from a plurality of speakers.

The computer may then also perform facial recognition on the actor shown in video of the video file and compare facial information against known information in the storage database 1610. The method may include determining the identity of the actor or determining the facial movements or ticks of the actor. The computer then compares the measured facial movements against stored information concerning the facial movements of the actor. Alternatively, the computer compares facial movement of the actor against an amalgam of facial movements obtained from a plurality of individuals and stored in the storage database.

The computer obtains user information concerning the author of the video file and compares the information about the author to known information stored in the storage database 1612. The information known about the author may include name, address, contact information, email, user profile, or any other identifying information.

The computer may obtain transaction information concerning the transaction backing the video file and compare the transaction information against transaction information in the video file 1614. The transaction information may include the item or service purchased, the time of the purchase, the shipment information, or any other information related to the purchase of the product or service contained in the video file.

The computer may obtain social media information about the author of the video file and compare the information in the video file against the social media information 1616. The social media information may include the username of the author, posts by the author on social media accounts, or any other information related to social media accounts or posts. If information obtained from the social media posts of the author matches information in the video file, the accuracy and trustworthiness of the video file is increased.

The computer may obtain any time stamp information of the video file and compare the transaction information to the time stamp information of the video file and compare information from the video file itself against the time stamp 1618. The computer may compare to ensure that the time stamp of the video file was after any purchase or after any time information contained in the content of the video file spoken or confirmed by the author himself

The computer may obtain the IP address of the computer used to create the video file and compare the IP address to information obtained from the video file and information known in the storage database 1620. The storage database may contain information about all video files created by a single IP address. The computer may thus compare the video file with a specific IP address against other video files with the same IP address to determine consistency and accuracy. The computer may compare the IP address to information obtained the text, video, audio, or content of the video file itself to determine accuracy- such as statements of geographic location. If the geographic location of the IP address matches statements about the actor's geographic location then the video file is determined to be accurate.

The computer then determines the accuracy or completeness of each item of information obtained concerning the video file and applies a weight value to each item of information 1622. If the information about one factor is complete or accurate, then the computer applies a higher weight value to that factor. If the information is less complete or less accurate then the computer applies a lower weight value.

Based on the weight values and information in each factor, the computer then creates the trust rating value for the video file, stores the trust rating value in the trust database, and creates a video file location reference pointing to the specific location of the video file in the public database.

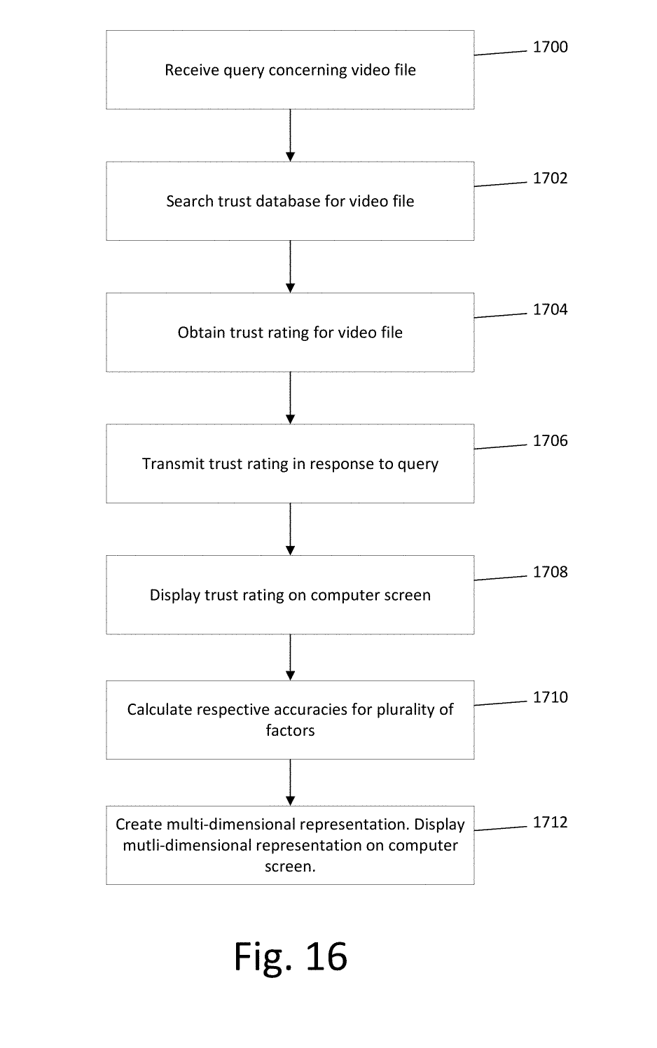

Referring to FIG. 16, the query process is illustrated. The server computer receives a query concerning a video file 1700. The query may be originated from a client computer, a second server computer, or a direct access query from the server computer operating the system. The server computer then searches the trust database for the video file 1702. The server computer finds the video file and obtains the trust rating for the video file 1704. The server computer transmits the trust rating in response to the query 1706. The computer system then displays the trust rating on the computer screen of the querying computer 1708. The server computer calculates the respective accuracies for the plurality of factors 1710. The server computer creates a multi-dimensional representation and the querying computer displays the multi-dimensional representation on the computer screen 1712. In other embodiments the display created may be in the form of a visual meter, a percentage value, or a specific color output depending on the trust value rating.

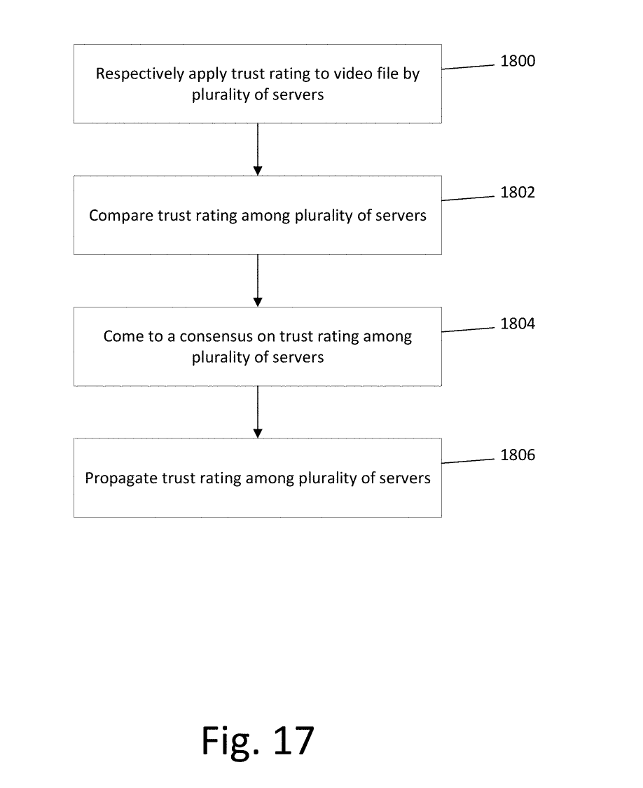

Referring to FIG. 17, the method of the invention may be utilized in blockchain fashion by a plurality of server computers. In this method, each server computer has a respective storage database and trust database. The plurality of server computers each respectively apply a trust rating to a video file 1800. The plurality of servers then compare the trust ratings of the video file 1802. The group of server computers then come to a consensus as to the trust rating 1804. Consensus may be reached by averaging the trust ratings together, accepting the trust rating of the server using the most complete set of information, or using any other predetermined method. Once consensus is reached, the group of server computers then propagate the trust rating among all server computers for storage in the respective trust databases.

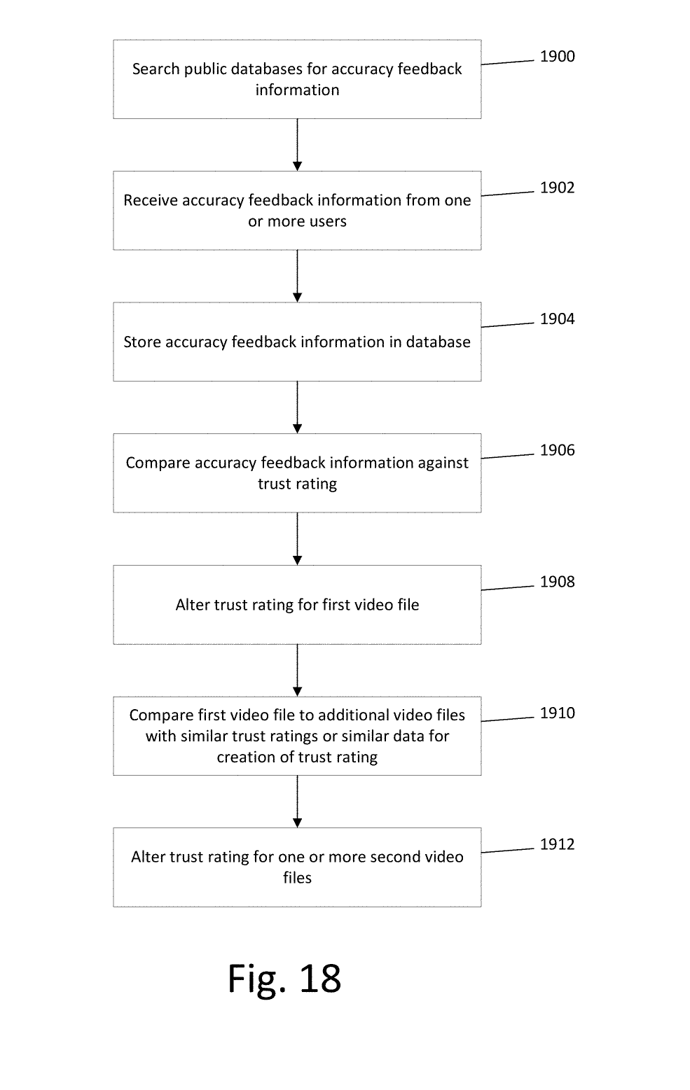

Referring to FIG. 18, the method of the invention may further comprise a self-correcting and self-improving method. The implementation of the self-correcting and self-improving method is an implementation of “artificial intelligence” to improve the operations of the computer system and method. First, the computer system may search public databases for accuracy feedback information 1900. “Accuracy feedback information” is any information related to public perception of a video file. Accuracy feedback information may include user rating information of a video file, such as “likes” or “dislikes.” Accuracy feedback information may include statements made by internet users in posts connected with a video. Such statements may include positive statements such as “I love this video.” or negative statements such as “I hate this video.” Accuracy feedback information may also include perception by internet users of the trust rating. The system may receive accuracy feedback information directly from one or more users 1902. Users may provide accuracy feedback information any number of forms including but not limited to (1) clicking “like” or “dislike” about a trust rating, (2) rating the helpfulness of a trust rating on a scale of one to ten, (3) providing text answers to a series of questions presented to users, or (4) any other active actions taken by users to provide direct feedback concerning the trust rating. Once received, the system stores the accuracy feedback information in a database 1904. The system may then compare the accuracy feedback information against the trust rating 1906. If the accuracy feedback information indicates that the trust rating is helpful then the system will confirm the trust rating. If the accuracy feedback information indicates that the trust rating is too low and that the video is more trustworthy then the system will increase the value of the trust rating. If the accuracy feedback information indicates that the trust rating is too high and that the video is less trustworthy then the system will decrease the value of the trust rating. In this manner, the system will alter the trust rating for a first video file 1908. The system may then compare the trust rating of the first video file to additional video files with a similar trust rating, or to additional video files which used similar data to create a trust rating 1910. The system may then alter the trust rating for one or more second video files 1912. For instance, if the trust rating of a first video file is altered based on accuracy feedback information, then the system may alter the trust rating value of a second video file that has a similar trust rating. As another example, if a trust rating value of a first video is based off of the report of a specific user and accuracy feedback information indicates that the trust rating of the first video file should be altered, then the system will review all video files where the trust rating is based off of a report by that specific user. The system may then alter the trust rating of those video files.

In another embodiment of the invention the product, service, or topic of the video file is assigned a unique identifier by the computer system. The unique identifier could be any alphanumeric identifier. The trust database file 1400 records may be organized by the unique identifier and the trust ratings of all video files bearing the same unique identifier may be compared. In other embodiment, each video file itself is assigned a unique identifier.

In other embodiments separate and distinct video files are compared against other video files. The trust rating of one video file may then be utilized to alter the trust rating of another video file. The computer system may average or the trust ratings together from separate video files where the video files pertain to the same subject matter. Additionally, other video files made by the same author may be utilized to adjust the trust rating of a specific video file.

In another embodiment of the invention, the method may be utilized as an API. The system can rate information and video files from other online video services, such as YouTube, video tweets, social media video posts, or other online video sources.

The system may further utilize an administrator who operates several accounts for utilizing the inventive system. The administrator may answer a series of questions in regards to the purpose of the software usage, including: parenting, marriage, courts, police, airport protection, FBI, immigration, gun shop, car/truck rental, schools, corporations, and or another uses defined by each administrator. The system may be utilized to analyze videos for accuracy and truth over time to help determine the overall level of truthfulness and accuracy of the questions answered to help determine mental health and if intent exists for terrorizing others. Administrators can customize questions. Administrators may utilize the system to track videos of a specific set of interviewees. The system will report back to administrators to help narrow down individuals that my pose a threat to others each day or week depending upon preferences chosen by the administrator. The software will contact people to download a client interface software portal or email them to signup through the interne. Thereafter, the interviews begin per the administrator's setup. The system will send regular updates to the administrator based on answers by interviewees- unanswered notifications, red flags, as well as detailed questions that show low confidence scores from interviewees will be sent to administrators regularly. The system may automatically notify the administrator by email, pop up, text message, or any other computerized form of notification.

In the preferred embodiment of the invention, the system measures microfacial movements of a person's face in a video. The detection of microfacial movements by the system presents a flag that the person in the video is lying and being untrustworthy. The system may then notify an administrator that the person in the video is lying, the video file 1200 is untrustworthy, or both.

First the system determines that a face of a human in shown in the video. The software determines the existence of reference points of facial features in the video. The software determines primarily the existence of two eyes, a nose, and a mouth. The software stores a set range of parameters for the placement and location of the facial features in a database. If the video shows the locations of the facial features within these parameters then the software identifies the existence of a human face. Although this method is the preferred method for identifying a human face in the video, other embodiments and methods may be utilized.

The software measures the positions and distance of the facial features from one another- distance of eyes to mouth, distance from mouth to nose, etc. The software may place multiple reference points on one facial feature. For instance, the software may place a reference point on each corner of the mouth or a reference point on the whites of a person's eyes and a reference point on the pupil of person's eyes.

The system stores several source files of a predetermined set of reference points. The source files may be images of human faces or raw data concerning the distances between reference points on facial features.

While a person in a video is talking the system constantly measures the locations of the reference points and distances between the reference points. As stored in the source files, the system has a predetermined set of reference point data that is determined to be untrustworthy. For instance, the system may store sets of preset facial positions, head positions, or head movements as untrustworthy. If the system determines the existence of any of these facial positions or head positions then the system may decrease the trust rating value of the video file 1200. Such reference positions and movements may include head movements, the person looking away, the person turning around, the person looking side to side, the person touching their face, the person touching their nose, the person fluttering their eyes, or any other set of reference data that may be chosen by the administrator.

The system may also do the same method with the audio of the video file to measure changes in the speaking of the person in the video file. The system may measure the pitch of a person's voice, changes in pitch, gulping, yawning, or any other sound.

When these facial positions and sounds are measured by the system, the software compares these measurements to sets of predetermined data in the source files stored in the database. Source files can include those files which are taken from public databases, or may even include a set of raw data points input by the administrator. The administrator may determine a set of preset values and store them as a source file. If the measurements of the video file are found to exist in a set of source files, then the system may adjust the trust rating value accordingly. For instance, one or more source files may show a certain configuration of reference points for facial data to be untrustworthy. When the system determines the existence of these configurations in the video file then the system adjusts the trust rating value. The system may also store a range of configuration data (range of distance of reference points between each other; range of change in distance of one particular reference point). The system may determine a facial configuration that falls within the set of values and adjust the trust rating accordingly.

Furthermore, the system may also measure the amount of time that a set of reference points is in a certain configuration (amount of time a person has a certain facial position). If any specific facial position is temporary and lasts for less than ½ second, then the system marks that set of reference points as a “microfacial expression” and sets a flag reference point. If the system determines the existence of more than a predetermined set of microfacial expressions then the system may lower the trust rating value of the video file 1200. For example, if the system detects from 0-1 microfacial expressions it gives the video file a high trust rating value. If the system detects 2-10 microfacial expressions, then it gives a low trust rating value.

In addition the following may be used as source files for determining the trust rating of video files: vouches, authentication, number of views, true votes, false votes, and video loops. The system may also be used as a cumulative algorithmic of all video files for ranking grouped video files. In the preferred embodiment the system utilizes microfacial expressions as the largest factor in detecting confidence and trust in video files. The system utilizes eye movements, touching/covering of the mouth, touching or itching of the nose, gulping, yawning, throat movements, eye movements, fluttering of the eye lids, body language, and of the rubbing the eyes. The system utilizes higher and lower pitches in vocal sounds to determine confidence and truth in a video file. All of the foregoing may be consolidated and reviewed for composing a trust rating value of a video file.

Video organization will help people find the level of truthfulness of Video Business Reviews, Video Product Reviews, Video Texting, Video Posting (Tweets), Face Time, Video Job Interviews, Video News, Seller/Buyer Video Shopping, Ranking Search Engines, Ranking Video Sites, Ranking eCommerce Sites, Spousal Cheating, Job Portals, Corporate Interviews, Social sites, Social Interactions, Video Ads, and Video Dating. These are some uses of the video organization system but not all.

The video organization method will also help to find the level of truthfulness in order to protect children, adults, immigration, courtrooms, interrogations, airports, schools, businesses, corporations, governments, gun shops (firearm sales), truck/car rentals, airlines, and other organizations to help determine truthfulness from bad actors. These are some uses of the video organization system but not all.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1) A computer implemented method, to be performed by one or more microprocessors, for automatically organizing and rating video files comprising
a) obtaining a first computer storage location for a first video file;
b) recording said first computer storage location to a database;
c) searching for one or more source files;
d) obtaining one or more source files;
e) extracting data from said one or more source files;
f) extracting data from said first video file;
g) comparing data from said one or more source files to data from said first video file;
h) generating a first trust rating value for said first video file; and
i) storing said first trust rating value in said database.

2) The computerized method as in claim 1 further comprising
a) obtaining a source file storage location for a source file; and
b) recording said source file storage location in a database.

3) The computerized method as in claim 1 wherein one of said one or more source files further comprises facial data information, said method further comprising
a) obtaining facial information from said first video file;
b) comparing facial information from said first video file to facial data information from said source file;
c) generating a facial information output value; and
d) incorporating said facial information output value into said first trust rating value.

4) The computerized method as in claim 1 wherein one of said one or more source files further comprises vocal data information, said method further comprising
a) obtaining vocal information from said first video file;
b) comparing said vocal information from said first video file to vocal data information from said source file;
c) generating a vocal information output value; and
d) incorporating said vocal information output value into said first trust rating value.

5) The computerized method as in claim 1 wherein one of said one or more source files further comprises source user profile information, said method further comprising
a) obtaining user profile information of an author of said first video file;
b) comparing source user profile information to user profile information of an author of said first video file;
c) generating a user profile output value; and
d) incorporating said user profile output value into said first trust rating value.

6) The computerized as in claim 1 wherein one of said one or more source files further comprises a first IP address of a computer, wherein said method further comprises
a) obtaining a second IP address of a computer;
b) comparing said first IP address to said second IP address;
c) generating an IP address output value; and
d) incorporating said IP address output value into said first trust rating value.

7) The computerized method as in claim 1 further comprising
a) obtaining one or more accuracy feedback values;
b) storing said one or more accuracy feedback values in a database;
c) comparing said one or more accuracy feedback values to said first trust rating value;
d) generating a second trust rating value for said first video file;
e) searching, in a database, for a second video file record pertaining to a second video file;
f) generating a third trust rating value for said second video file;
g) storing said third trust rating value in a database; and
h) altering said second video file record to reflect said third trust rating value.

8) The computerized method as in claim 1 further comprising
a) respectively receiving one or more second trust rating values for said first video file from one or more second computers;
b) comparing said first trust rating value to said one or more second trust rating values;
c) generating a third trust rating value for said first video file; and
d) transmitting said third trust rating value to one or more second computers.

9) The computerized method as in claim 1 further comprising
a) determining one or more spoken words in an audio track of said first video file;
b) generating a transcript of said one or more spoken words in said audio track of said first video file; and
c) storing said transcript in a database.

10) The computerized method as in claim 9 wherein one of said one or more source files further comprises a wordlist, said method further comprising
a) comparing said transcript to said word list;
b) generating a word list output value; and
c) incorporating said word list output value into said first trust rating value.

11) The computerized method as in claim 9 wherein one of said one or more source files further comprises transaction information, said method further comprising
a) comparing transaction information to said transcript;
b) generating a transaction output value; and
c) incorporating said transcript output value into said first trust rating value.

12) The computerized method as in claim 9 further comprising
a) generating a list of words appearing in said transcript;
b) respectively determining a number of times each word in said list of words appears in said transcript;
c) generating a lexicon output value; and
d) incorporating said lexicon output value into said first trust rating value.

13) The computerized method as in claim 9 further comprising
a) obtaining metadata related to said first video file;
b) comparing said metadata related to said transcript;
c) generating a metadata output value; and
d) incorporating said metadata output value into said first trust rating value.

14) The computerized method as in claim 1 further comprising
a) generating two or more source file output values;
b) respectively applying a weight value to said two or more source file output values; and
c) incorporating said two or more source file output values into said first trust rating value after applying said weight value.

15) The computerized method as in claim 14 further comprising generating a visual representation of two or more source file output values, wherein said visual representation is configured as a multi-dimensional space image.

16) The computerized method as in claim 1 wherein one of said one or more source files further comprises facial data information, wherein one of said one or more source files further comprises vocal data information, and wherein one of said one or more source files further comprises source user profile information, said method further comprising
a) obtaining facial information from said first video file;
b) comparing facial information from said first video file to facial data information from said source file;
c) generating a facial information output value;
d) incorporating said facial information output value into said first trust rating value.
e) obtaining vocal information from said first video file;
f) comparing said vocal information from said first video file to vocal data information from said source file;
g) generating a vocal information output value;
h) incorporating said vocal information output value into said first trust rating value;
i) obtaining user profile information of an author of said first video file;
j) comparing source user profile information to user profile information of an author of said first video file;
k) generating a user profile output value; and
l) incorporating said user profile output value into said first trust rating value.

17) The computerized method as in claim 16, wherein one of said one or more source files further comprises a wordlist, and wherein one of said one or more source files further comprises transaction information, wherein one of said one or more source files further comprises a first IP address of a computer, said method further comprising
a) determining one or more spoken words in an audio track of said first video file;
b) generating a transcript of said one or more spoken words in said audio track of said first video file;
c) storing said transcript in a database;
d) comparing said transcript to said word list;
e) generating a word list output value;
f) incorporating said word list output value into said first trust rating value;
g) comparing transaction information to said transcript;
h) generating a transaction output value;
i) incorporating said transcript output value into said first trust rating value;
j) generating a list of words appearing in said transcript;
k) respectively determining a number of times each word in said list of words appears in said transcript;
l) generating a lexicon output value;
m) incorporating said lexicon output value into said first trust rating value;
n) obtaining metadata related to said first video file;
o) comparing said metadata related to said transcript;
p) generating a metadata output value;
q) incorporating said metadata output value into said first trust rating value;
r) obtaining a second IP address of a computer;
s) comparing said first IP address to said second IP address;
t) generating an IP address output value; and
u) incorporating said IP address output value into said first trust rating value.
v) obtaining a source file storage location for a source file;
w) recording said source file storage location in a database;
x) receiving a query from a communicatively connected computer;
y) searching a database for a video file record;
z) identifying a video file record responsive to said query;
aa) transmitting an answer to said query;
bb) obtaining one or more accuracy feedback values;
cc) storing said one or more accuracy feedback values in a database;
dd) comparing said one or more accuracy feedback values to said first trust rating value;
ee) generating a second trust rating value for said first video file;
ff) searching, in a database, for a second video file record pertaining to a second video file;
gg) generating a third trust rating value for said second video file;
hh) storing said third trust rating value in a database;
ii) altering said second video file record to reflect said third trust rating value;
jj) respectively receiving one or more fourth trust rating values for said first video file from one or more second computers;
kk) comparing said second trust rating value to said one or more fourth trust rating values;
11) generating a fifth trust rating value for said first video file; and
mm) transmitting said fifth trust rating value to one or more second computers.

18) A computer implemented method, to be performed by one or more microprocessors, for automatically organizing and rating video files comprising
a) obtaining a first computer storage location for a first video file;
b) recording said first computer storage location to a database;
c) extracting data from one or more source files stored in a database;
d) determining the existence of two or more reference points for facial features in said video file;
e) determining that said two or more reference points are in a first configuration;
f) comparing said first configuration of two or more reference points to one or more source files;
g) generating a first trust rating value for said first video file; and
h) storing said first trust rating value in said database.

19) The computer implemented method as in claim 18 further comprising measuring an amount of time two or more reference points are in said first configuration.

20) The computer implemented method as in claim 18 further comprising
a) determining said two or more reference points are in a second configuration; and
b) comparing said first configuration to said second configuration.
